(19) United States
(12) Patent Application Publication
(10) Pub. No.: US 2005/0138069 A1
(43) Pub. Date: Jun. 23, 2005

(54) Providing a playlist package of digitized entertainment files for storage and playback

(75) Inventor: Stephen C. Habermas, Beverly Hills, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/740,871

(22) Filed: Dec. 19, 2003

(51) Int. Cl. G06F 7/00

(52) U.S. Cl. 707/104.1

(57) ABSTRACT

The invention provides a system and method for providing a user prescribed playlist package of digitized entertainment files. A playlist package request is received at a call center. The playlist package is created based on the playlist package request. The playlist package comprises a plurality of digitized entertainment files and a playlist package information file. The playlist package is then sent to a digitzed entertainment file storage system. Another aspect of the invention provides a computer usable medium that includes program code for providing a user prescribed playlist package of digitized entertainment files.

### FIELD OF THE INVENTION

This invention relates generally to digitized entertainment files. In particular the invention relates to a system and method for providing a user prescribed playlist package of digitized entertainment files.

### BACKGROUND OF THE INVENTION

One of the fastest growing areas of communications technology is related to automobile network solutions. Although many vehicles on the road today have limited wireless communication functions, such as unlocking a door and setting or disabling a car alarm, new vehicles offer additional wireless communication systems that help personalize comfort settings, run maintenance and diagnostic functions, place telephone calls, access call-center information, update controller systems, determine vehicle location, assist in tracking vehicle after a theft of the vehicle and provide other vehicle-related services. Drivers can call telematics call centers to receive navigational, concierge, emergency, and location services, as well as other specialized help such as locating the geographical position of a stolen vehicle and honking the horn of a vehicle when it cannot be located in a large parking garage.

Portable entertainment has made evolutionary changes with the advent of digital technology. Music, movies, books, and many other types of media can be converted to digital format and stored for future playback. Portable CD players, portable DVD players and portable book readers allow playback of digitized entertainment files almost anywhere. Portable MP3 players can store and playback hours of digitized music files. These same technologies have been implemented in vehicles, which now come with built in CD players and DVD players.

If a vehicle owner desires to playback digitized entertainment files such as mp3 music files or avi movie files they must first burn those files on a CD or DVD. The CD or DVD is then played back in the vehicle's CD or DVD player. Control of music or movie selection and playback order is limited with playback systems installed in a vehicle or with portable playback systems. Many users are frustrated with the lack of effective control of the exact set of digitized entertainment files they would like to have available to them and the lack of effective navigation among the files. Users can skip forward and back among files and repeat various selections but direct access based on a specific title, artist, scene, or other parameter is not available without pre-programming the playback system.

It is desirable therefore, to provide a system and method for providing a user prescribed playlist package of digitized entertainment files, that overcomes the challenges and obstacles described above.

### SUMMARY OF THE INVENTION

The present invention provides a method for providing a user prescribed playlist package of digitized entertainment files. A playlist package request is received at a call center. The playlist package is created based on the playlist package request. The playlist package comprises a plurality of digitized entertainment files and a playlist package information file. The playlist package is then sent to a digitzed entertainment file storage system.

Another aspect of the present invention provides a computer usable medium including computer program code for providing a user prescribed playlist package of digitized entertainment files. The computer program code receives playlist package request at a call center. The computer program code creates the playlist package based on the playlist package request. The playlist package comprises a plurality of digitized entertainment files and a playlist package information file. The computer program code then sends the playlist package to a digitzed entertainment file storage system.

Another aspect of the present invention provides means for providing a user prescribed playlist package of digitized entertainment files. The system comprises: means for receiving a playlist package request at a call center and means for creating the playlist package based on the playlist package request. The playlist package comprises a plurality of digitized entertainment files and a playlist package information file. The system further comprises means for sending the playlist package to a digitzed entertainment file storage system.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for providing a user prescribed playlist package of digitized entertainment files in accordance with one embodiment of the current invention;

FIG. 2 is a flow diagram of a method for creation and delivery of a playlist package of digitized entertainment files in accordance with one embodiment of the current invention;

FIG. 3 is a flow diagram of a method for playback of a playlist package of digitized entertainment files in accordance with one embodiment of the current invention; and

FIG. 4 is a schematic of one embodiment of a system for storage and playback of a playlist package of digitized entertainment files in accordance with the current invention.

### DETAILED DESCRIPTION OF THE PRESENTLY PREFERRED EMBODIMENTS

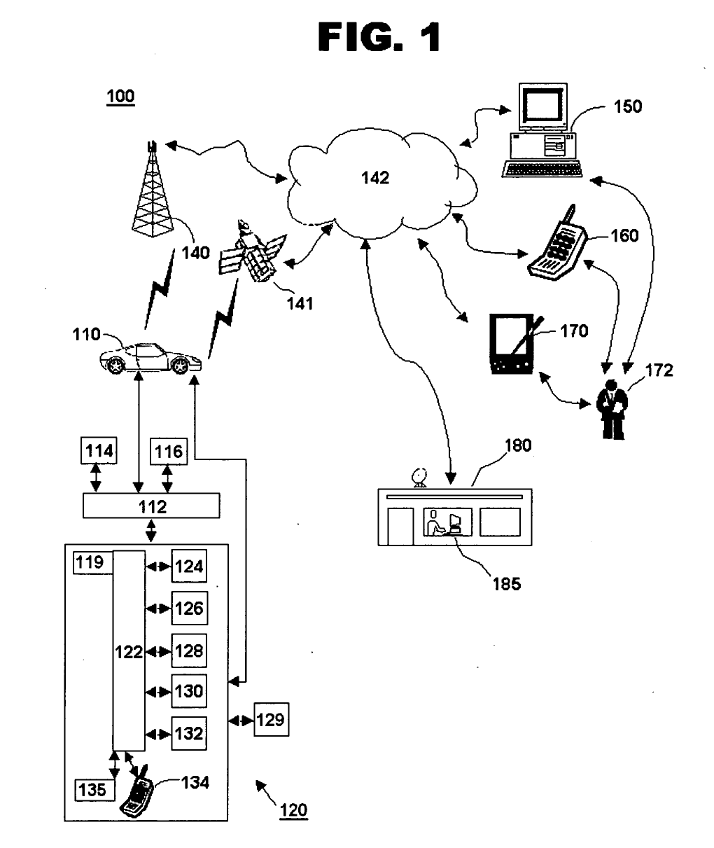

FIG. 1 is a schematic diagram of a system for providing a user prescribed playlist package of digitized entertainment files in accordance with one embodiment of the current invention at 100. Playlist package provisioning system 100 includes a mobile vehicle 110, a telematics unit 120 that functions as a playlist package storage system, one or more wireless carrier systems 140 or satellite carrier systems 141, one or more communication networks 142, and one or more call centers 180. Mobile vehicle 110 is a vehicle such as a car or truck equipped with suitable hardware and software for transmitting and receiving voice and data communications.

In one embodiment of the invention, telematics unit 120 includes a digital signal processor (DSP) 122 connected to a wireless modem 124, a global positioning system (GPS) receiver or GPS unit 126, an in-vehicle memory 128, a microphone 130, one or more speakers 132, an embedded or in-vehicle phone 134 or email access appliance 135 and includes a file system (not shown) for handling digitized entertainment files. DSP 122 is also referred to as a microcontroller, controller, host processor, or vehicle communications processor. GPS unit 126 provides longitude and latitude coordinates of the vehicle, as well as a time stamp and a date stamp. In-vehicle phone 134 is an analog, digital, dual-mode, dual-band, multi-mode or multi-band cellular phone.

Telematics unit 120 can store digitized entertainment files and other data files in in-vehicle memory 128. Telematics unit 120 can set or reset calling-state indicators and can enable or disable various cellular-phone, telematics-unit functions and vehicle components when directed by program code running on DSP 122. Telematics unit 120 can send and receive over-the-air messages using, for example, a pseudo-standard air-interface function or other proprietary and non-proprietary communication links.

DSP 122 executes various computer programs and computer program code that control programming and operational modes of electronic and mechanical systems within telematics unit 120. DSP 122 controls communications between telematics unit 120, wireless carrier system 140 or satellite carrier system 141 and call center 180. A voice-recognition engine 119, which can translate human voice input through microphone 130 to digital signals, is installed in telematics unit 120. The interface to telematics unit 120 includes one or more buttons on the telematics unit, radio console, or associated keyboard or keypad. In another embodiment, the interface to telematics unit 120 includes other forms of preference and data entry including touch-screens, wired or wireless keypad remotes, or other wirelessly connected devices such as Bluetooth-enabled devices or 802.11-enabled devices.

DSP 122 controls, generates and accepts digital signals transmitted between telematics unit 120 and a vehicle communication bus 112 that is connected to various vehicle components 114 and sensors 116 in mobile vehicle 110. DSP 122 can activate various programming and operation modes, as well as provide for data transfers. In one embodiment of the invention, signals from DSP 122 are translated into voice messages and sent out through speaker 132. Generated voice messages include a command prompt, a prompt for information, a password prompt or a feedback messages verifying that a command has been executed or was not understood.

In one embodiment of the invention a playlist package of digitized entertainment files is created at call center 180 by call center advisor 185 based on a received playlist package request. Playlist package request is received at call center 180 from telematics unit 120, user computer 150, wireless or wired phone 160, or handheld device 170 through communication network 142. Call center advisor 185 sends the created playlist package to playlist package storage system or telematics unit 120 via communications network 142. Received playlist package of digital entertainment files is stored in in-vehicle memory 128. DSP 122 controls the transfer of the digitized entertainment files from the playlist package in vehicle memory 128 to digitized entertainment file playback system 129. DSP 122 through voice recognition engine 119 responds to voice commands requesting a particular digitized entertainment file or some combination thereof for playback. Digitized entertainment file playback system 129 is an audio system or audio-visual system designed to provide decoding and playback of digitized entertainment files. In another embodiment of the invention, digitized entertainment file playback system 129 is integrated into the playlist package storage system or telematics unit 120.

Mobile vehicle 110 via telematics unit 120 sends and receives radio transmissions from wireless carrier system 140, or satellite carrier system 141. Wireless carrier system 140, or satellite carrier system 141 is any suitable system for transmitting a signal from mobile vehicle 110 to communication network 142.

Communication network 142 includes services from mobile telephone switching offices, wireless networks, public-switched telephone networks (PSTN), and Internet protocol (IP) networks. Communication network 142 comprises a wired network, an optical network, a fiber network, another wireless network, or any combination thereof. Communication network 142 connects to mobile vehicle 110 via wireless carrier system 140, or satellite carrier system 141. Communication network 142 connects wireless carrier system 140 or satellite carrier system 141 to user computer 150, wireless or wired phone 160, handheld device 170, such as a personal digital assistant, and call center 180.

Communication network 142 can send and receive short messages according to established protocols such as IS-637 standards for short message service (SMS), IS-136 air-interface standards for SMS, and GSM 03.40 and 09.02 standards. In one embodiment of the invention, similar to paging, an SMS communication is posted along with an intended recipient, such as a communication device in mobile vehicle 110.

Call center 180 is a location where many calls are received and serviced at the same time, or where many calls are sent at the same time. In one embodiment of the invention, the call center is a telematics call center, prescribing communications to and from telematics unit 120 in mobile vehicle 110. In another embodiment, the call center 180 is a voice call center, providing verbal communications between a communication services advisor 185 in the call center 180 and a subscriber. In another embodiment, the call center 180 contains each of these functions.

Communication services advisor 185 is a real advisor or a virtual advisor. A real advisor is a human being in verbal communication with a user or subscriber. A virtual advisor is a synthesized voice interface responding to requests from user or subscriber. In one embodiment, virtual advisor includes one or more recorded messages. In another embodiment, virtual advisor generates voice messages using a text to speech synthesis engine (TTS). In another embodiment virtual advisor includes both recorded and TTS generated messages.

Call center 180 provides services to telematics unit 120. Communication services advisor 185 provides one of a number of support services to a subscriber. One such service is processing a playlist package request. Playlist package requests are received at call center 180 via telephone or internet enabled interface. Communication service advisor 185 accepts the playlist package request and generates the playlist package before forwarding it to the appropriate playlist package storage system. Call center 180 can transmit data via data signal, such as a vehicle data upload (VDU), to telematics unit 120 in mobile vehicle 110 through wireless carrier system 140, satellite carrier systems 141, or communication network 142.

Call center 180 can determine mobile identification numbers and telematics unit identifiers associated with a telematics unit access request, compare mobile identification numbers and telematics unit identifiers with a database of identifier records, and send calling-state messages to the telematics unit 120 based on the request and identification numbers.

In one embodiment of the invention, user 172 has a local provisioning system such as user computer 150 or handheld device 170. Local provisioning system has a wireless modem to send data through wireless carrier system 140, or satellite carrier system 141, which connects to communication network 142. In another embodiment, local provisioning system has a wired modem, which connects to communications network 142. Data is received at call center 180. Call Center 180 has any suitable hardware and software capable of providing web services to help transmit messages and data signals from local provisioning system, such as, user computer 150 or handheld device 170 to telematics unit 120 in mobile vehicle 110. In another embodiment, user computer 150 or handheld device 170 has suitable hardware and software to connect to mobile vehicle 110 using a direct link to a mobile vehicle onboard data port.

In one embodiment, voice recognition software is installed in telematics unit 120 and is referred to as a voice recognition engine 119. Voice recognition software is executed by DSP 122. Pressing a button in vehicle 110 activates voice recognition engine 119. Pressing the button sends a discrete signal that places the telematics unit in audio arbitration mode allowing it to respond to voice commands. In another embodiment of the invention, pressing a button in vehicle 110 initiates communication with call center advisor 185.

In another embodiment of the invention, playlist package storage system is a portable entertainment system such as a CD player, MP3 player, or DVD player. The portable entertainment system has appropriate hardware and software to receive and manage a playlist package of digitized entertainment files. The portable entertainment system would include hardware and software to process and respond to voice commands.

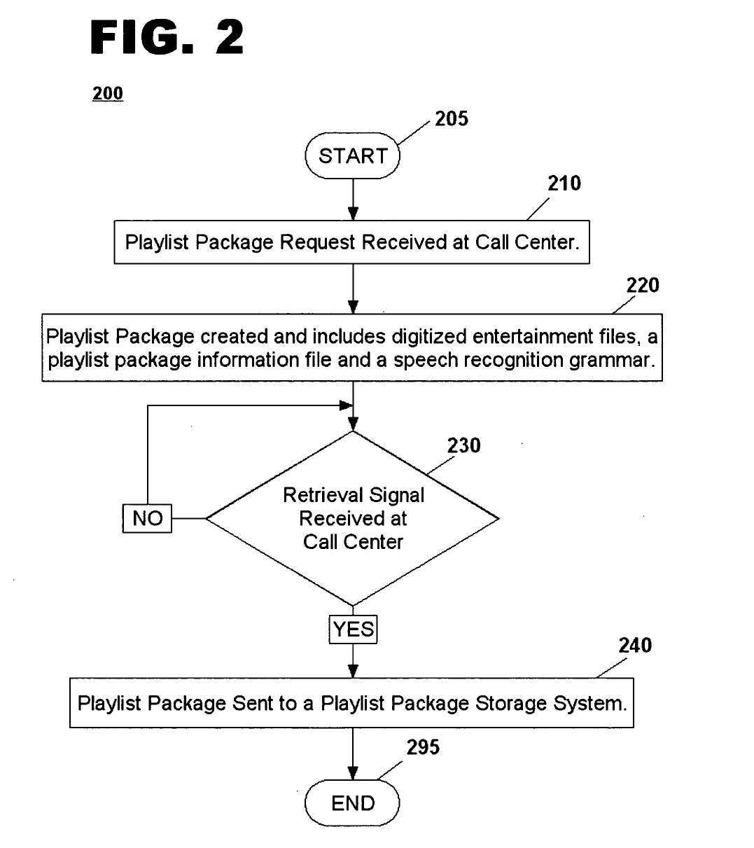

FIG. 2 is a flow diagram of a method for creation and delivery of a playlist package of digitized entertainment files in accordance with one embodiment of the current invention. The method for creation and delivery of a playlist package of digitized entertainment files at 200 begins (block 205) when the call center receives a playlist package request (block 210). The playlist package request comprises a list of digitized entertainment files that a user wishes to have available to them. Digitized entertainment files include, but are not limited to, music in .mp3 format, movies in .avi or mpeg format, and books in .rtf, .txt, or .doc format. The user can create this playlist package request in one of a number of ways. The user can use a call center web site to select the digitized entertainment files and submit the playlist package request. The user may also interact with a live or virtual advisor to select the digitized entertainment files and submit the playlist package request. In one embodiment of the invention, the user presses a button on a telematics unit to initiate communication with the advisor. In another embodiment, the user may contact an advisor using wireless phone or wired phone. In another embodiment the user may contact the advisor via electronic mail, or a web interface.

Once the playlist package request is received the call center will create the playlist package (block 220). The playlist package contains the requested digitized entertainment files, a playlist package information file that includes various data keys, such as artist data, title data, time data, scene data or other appropriate data keys, and a speech recognition grammar that is able to return speech recognition engine results corresponding to the data keys. The speech recognition grammar is a set of commands, including their format, which are recognized by the speech recognition engine. The speech recognition engine recognizes this grammar and converts the voice command into the appropriate digital signal to control the selection and playback of digitized entertainment files in the playlist package. The playlist package will be sent to the playlist package storage system when a retrieval signal is received at the call center (block 230). Until the retrieval signal is received the playlist package is stored at the call center. The retrieval signal is either a voice command requesting the delivery of the playlist package or a discrete signal generated when a button is pressed on the playlist package storage system. When the retrieval signal is received at the call center, a data connection is established with the playlist package storage system and the playlist package is sent to the playlist package storage system (block 240). The data connection can be a wireless connection, for example, a CDMA phone, or a hard-wired connection such as a DSL internet connection. Upon completion of the playlist package delivery the method ends (block 295).

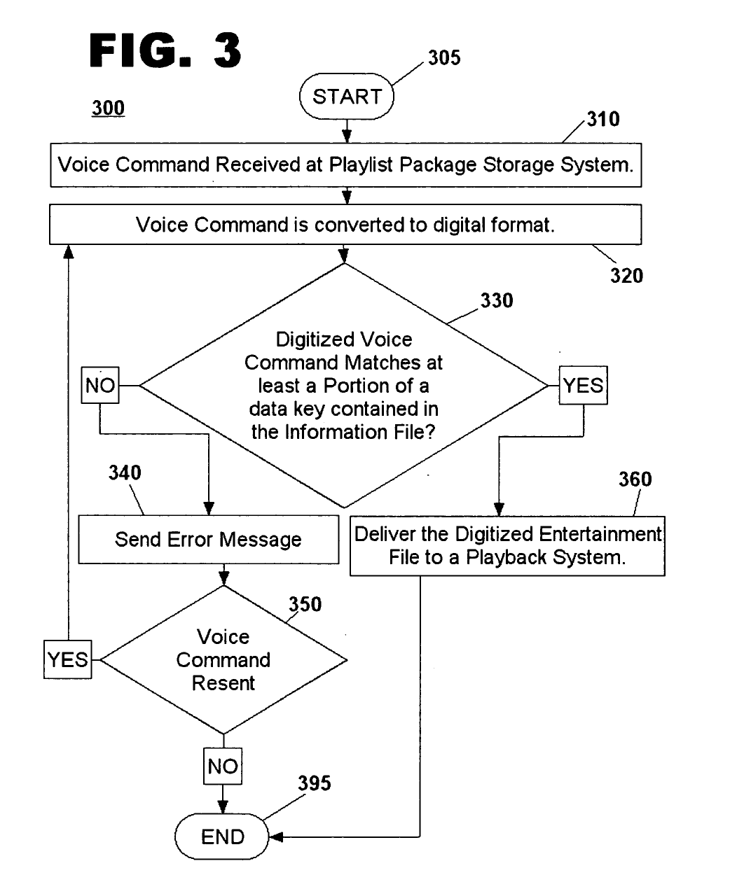

FIG. 3 is a flow diagram of a method for playback of a playlist package of digitized entertainment files in accordance with one embodiment of the current invention. The method for playback of a playlist package of digitized entertainment files at 300 begins (block 305) when the playlist package storage system receives a voice command to playback a specific digitized entertainment file or a set of files (block 310). The voice command is received at the playlist package storage system and converted to digital format (block 320). Possible voice commands include but are not limited to: a command to play all digitized entertainment files in sequential or random order; a command specifying a specific file or set of files based on a particular data key, such as all files by a particular artist; or a command specifying a generic navigation scheme, such as next, previous, skip, random shuffle, or intro only. The voice command matches either a portion of the data in the playlist package information file or no match is found (block 330).

If the voice command does not match a portion of the data in the information file, an error message is sent (block 340). The voice command is either resent or not resent (block 350). If the voice command is resent, the processing of the voice command is repeated (block 320). If the voice command is not resent the method ends (block 395).

If the voice command matches a portion of the data in the playlist package information file, the digitized entertainment file associated with matched data is delivered to a digitized entertainment file playback system (block 360) and the method ends (block 395).

In another embodiment of the invention, a visual display interface is provided for controlling playback of the digitized entertainment files in the playlist package. The visual display includes the listing of the available digitized entertainment files and a selection of navigation commands for controlling playback of the files. In another embodiment of the invention a button interface is provided for controlling playback of the digitized entertainment files in the playlist package. The button interface offers more limited playback control unless a full alpha-numeric keypad is provided for entering data keys.

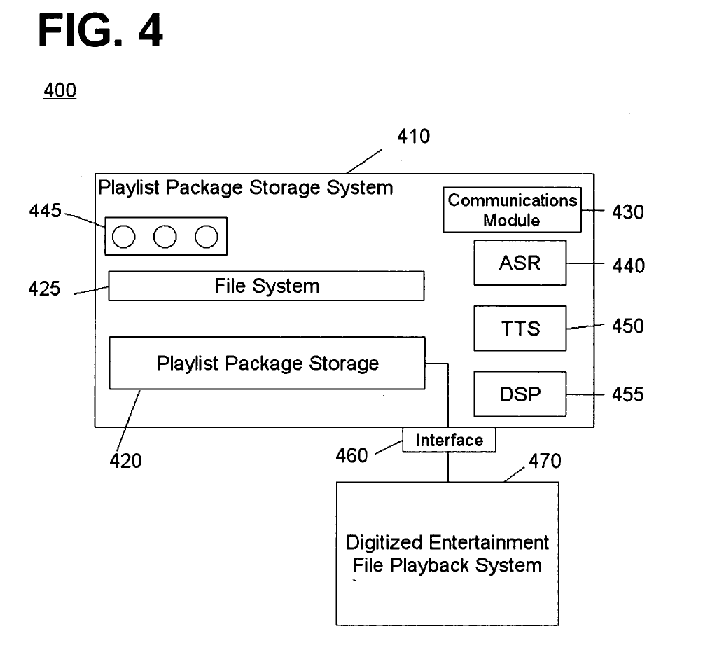

FIG. 4 is a schematic of one embodiment of a system for storage and playback of a playlist package of digitized entertainment files in accordance with the current invention at 400. The playlist package storage system 410 comprises a memory 420 for storing a playlist package of digitized entertainment files and a file system 425 for managing the playlist package. The playlist package storage system 410 further comprises a communications module 430 such as a wireless phone, wireless modem, wired modem, or physical data port. The playlist package storage system 410 also comprises a speech recognition engine (ASR) 440 that supports dynamically updating a speech recognition grammar and a text to speech synthesizer (TTS) 450 that supports the voice interface by producing the speech used in dialogue with the user. The speech recognition engine process voice commands spoken by the user. Examples of voice commands are a command to retrieve the playlist package from the call center or a command to play a particular digitized entertainment file. The text to speech synthesizer 450 is not required if replaced by an interface consisting of pre-recorded, for example, .wav files that comprise the speech used in dialogue with the user. In another embodiment the playlist package storage system has a button interface 445. A button press on the button interface sends a discrete signal that directs the playlist package storage system to execute a particular function. One such function is communication with the call center. Examples of other functions are delivery of the playlist package and playback of the playlist package. The playlist package storage system 410 further comprises an interface 460 for delivering the digitized entertainment files to the digitized entertainment file playback system 470. The playlist package storage system has a digital signal processor (DSP) 455 that executes program code such as speech recognition software, text to speech synthesis software, communication software, and interface software. DSP 455 manages the storage and delivery of the playlist package through file system 425. The digitized entertainment file playback system 470 comprises appropriate hardware and software for decoding and playing back the digitized entertainment files.

In an alternate embodiment of the invention, the digitized entertainment file playback system is integral to the playlist package storage system. In this alternate embodiment, the playlist package storage system provides all the functions of both units and allows for greater portability of the playlist package storage system. A user can receive, store, and playback a playlist package of digitized entertainment files using a single component. Speech recognition software comprising a speech recognition engine installed in the playback system allows voice control of a playback system where the playback system includes a microphone for receiving voice commands. The playback system must be capable of decoding each of the desired digitized entertainment file types, such as .mp3, .avi, mpeg, .pdf, or .rtf. A portable mp3 player, for example, can have the proper hardware software to receive a playlist package from a call center, to store the playlist package, and to control playback of digitized entertainment files having an mp3 format. In another example a telematics unit includes hardware and software for playback of files with an .mp3 format.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for providing a user prescribed playlist package of digitized entertainment files comprising:
receiving a playlist package request at a call center;
creating a playlist package based on the playlist package request, wherein the playlist package comprises a plurality of digitized entertainment files and a playlist package information file; and
sending the playlist package to a playlist package storage system.

2. The method of claim 1 wherein the playlist package further comprises a speech recognition grammar.

3. The method of claim 2 wherein the playlist package information file comprises the speech recognition grammar.

4. The method of claim 2 wherein the playlist package is sent to the playlist package storage system when a retrieval signal is received at the call center.

5. The method of claim 1 wherein the playlist package storage system is a telematics unit.

6. The method of claim 2 further comprising: receiving a voice command for a data key at the playlist package storage system; digitizing the voice command; and determining whether the digitized voice command matches at least a portion of a data key contained within the information file.

7. The method of claim 6 further comprising delivering a digitized entertainment file associated with a matched data key to a digitized entertainment file playback system.

8. The method of claim 7 wherein the playlist package storage system comprises the digitized entertainment file playback system.

9. A computer usable medium including computer program code for providing a user prescribed playlist package of digitized entertainment files comprising:
computer program code for receiving a playlist package request at a call center;
computer program code for creating a playlist package based on the playlist package request, wherein the playlist package comprises a plurality of digitized entertainment files and a playlist package information file; and
computer program code for sending the playlist package to a playlist package storage system.

10. The computer usable medium of claim 9 wherein the playlist package further comprises a speech recognition grammar.

11. The computer usable medium of claim 10 wherein the playlist package information file comprises the speech recognition grammar.

12. The computer usable medium of claim 10 wherein the computer program code for sending the playlist package to the playlist package storage system is executed when a retrieval signal is received at the call center.

13. The computer usable medium of claim 9 further comprising: computer program code for receiving a voice command for a data key at the playlist package storage system; computer program code for digitizing the voice command; and computer program code for determining whether the digitized voice command matches at least a portion of a data key contained within the information file.

14. The computer usable medium of claim 13 further comprising computer program code for delivering a digitized entertainment file associated with a matched data key to a digitized entertainment file playback system.

15. A system for providing a user prescribed playlist package of digitized entertainment files comprising:
means for receiving a playlist package request at a call center;
means for creating a playlist package based on the playlist package request, wherein the playlist package comprises a plurality of digitized entertainment files and a playlist package information file; and
means for sending the playlist package to a playlist package storage system.

16. The system of claim 14 wherein the playlist package further comprises a speech recognition grammar.

17. The system of claim 15 wherein the playlist package information file comprises the speech recognition grammar.

18. The system of claim 16 wherein the means for sending the playlist package to the playlist package storage system comprises means for receiving a retrieval signal at the call center.

19. The system of claim 14 wherein the playlist package storage system is a telematics unit.

20. The system of claim 14 further comprising: means for receiving a voice command for a data key at the playlist package storage system; means for digitizing the voice command; and means for determining whether the digitized voice command matches at least a portion of a data key contained within the information file.

21. The system of claim 20 further comprising means for delivering a digitized entertainment file associated with the matched data key to a digitized entertainment file playback system.

22. The system of claim 21 wherein the playlist package storage system comprises the digitized entertainment file playback system.
